(19) United States
(12) Patent Application Publication
(10) Pub. No.: US 2015/0284938 A1
(43) Pub. Date: Oct. 8, 2015

(54) Pop-Up Stopper for Bathroom Sinks with Hair Filter and Compatible with Current Pop-Up Stopper Design

(71) Applicant: Marie Lechaton, Wappingers Falls, NY (US)

(72) Inventor: Marie Lechaton, Wappingers Falls, NY (US)

(21) Appl. No.: 14/246,087

(22) Filed: Apr. 5, 2014

(51) Int. Cl. E03C 1/262; B23P 15/00; E03C 1/23

(52) U.S. Cl. CPC E03C 1/262; E03C 1/2302; B23P 15/002

(57) ABSTRACT

In a first embodiment, an improved pop-up stopper is described with a filter under the top of the pop-up stopper and recessed in the drain for ease cleaning. The top of the pop-up stopper can be easily removed for cleaning and replacing the filter with out having to disassemble the remaining pop-up structure under the sink. In a second embodiment, the filter is inverted for easy cleaning when the pop-up stopper is in the open position.

### BACKGROUND OF THE INVENTION

(1) Field of the Invention

This invention provides a pop-up stopper with a filter for a bathroom wash basin. The stopper is an improvement over the current stopper by including a novel filter to prevent hair and other drain clogging derby from clogging the drain. The filter is designed to be compatible with current pop-up stopper design while allowing the user to easily remove the filter and/or clean the filter. In a second embodiment an inverted filter is used so that the filter can be cleaned without removing the top from the pop-up stopper.

(2) Description of the Prior Art

One method in the market for removing clogs in the drain is to utilize (insert) a narrow brush in the drain when the POP-UP stopper is in the up position. This apparatus is used to clean already clogged drains, but does not prevent the drain from clogging.

Also, a number of pop-up stoppers have been patented with filters (screens), but require substantial design changes to retrofit the filter to the sink drain. For example, in U.S. Pat. No. 8,011,030 B2 a filter structure and method are described for a pop-up stopper. However, in this patent the filter in this pop-up stopper is not compatible with the current POP-UP stopper mechanism. The user is required to open and close the stopper in the basin area. Therefore, this apparatus and method require the user to extend their hands into the used water in the basin area to raise the stopper to drain the basin. Another example is in U.S. patent application publication 2009/0151060. In this publication a series of bristles are used to snag hair and other large particles. However, the bristles snagger must be removed to clean the POP-UP stopper.

Therefore, there is still a strong need in the consumer market for an improved pop-up stopper that has a filter or screen which is compatible with the current pop-up design that is easy to clean at the top of the POP-UP stopper and can still be opened and closed using a plunger device on the back of the sink.

### SUMMARY OF THE INVENTION

A principal object of this present invention is to provide a pop-up stopper for a bathroom basin drain having a filter or sieve.

A second objective, is to provide an apparatus designed so that the filter can be easily removed without having to disassemble the complete pop-up stopper (assembly) unit.

A third objective, by a first embodiment, is to provide a cup or cone shaped filter that is concentric and positioned under top of the stop and recessed in the drain when the POP-UP stopper is in the up position. The top of the stopper can be easily removed by unscrewing or using a bayonet type connection or the like to clean the filter (screen).

A fourth objective, by a second embodiment, is to provide a cylinder shaped filter in an inverted position so that the screen can be cleaned when the pop-top is in the up position and without removing the top of the pop-up stopper.

In accordance with the objects of the present invention of a pop-up stopper with a filter, the pop-up top is designed to be easily removed for cleaning or cleaning the filter without the need to disassemble the remaining plunger assembly.

### BRIEF DESCRIPTION OF THE DRAWINGS

FIG. 1 shows a schematic top view of a portion of a bathroom basin (2) having a pop-up stopper (8) with a filter (6) according to the first embodiment.

FIG. 2 shows a schematic cross-sectional view through 1-1′ of

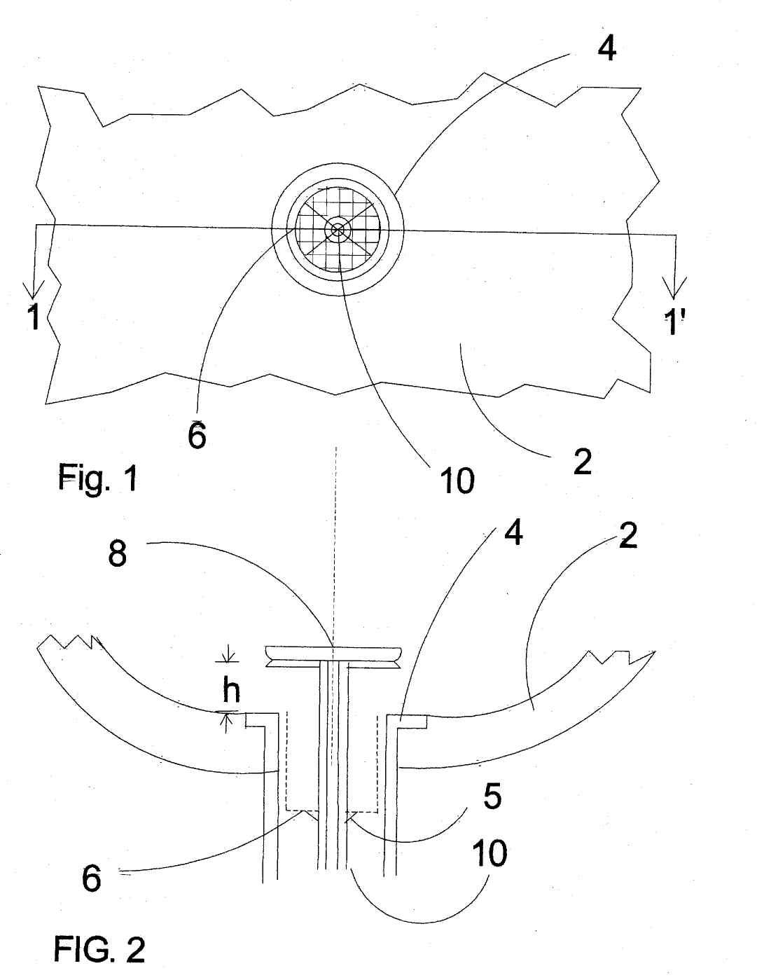

FIG. 1, through a portion of basin 2 having a drain 4 and the pop-up stopper(8) with a filter(6).

FIG. 3 shows a schematic top view of a portion of a bathroom basin(2) having a pop-up stopper (8) with an inverted filter (7) according to the second embodiment.

FIG. 4 shows a schematic cross sectional view through 3-3′ of FIG. 3, through a portion of basin 2 having a drain 4 and the pop-up stopper (8) with an inverted filter(7).

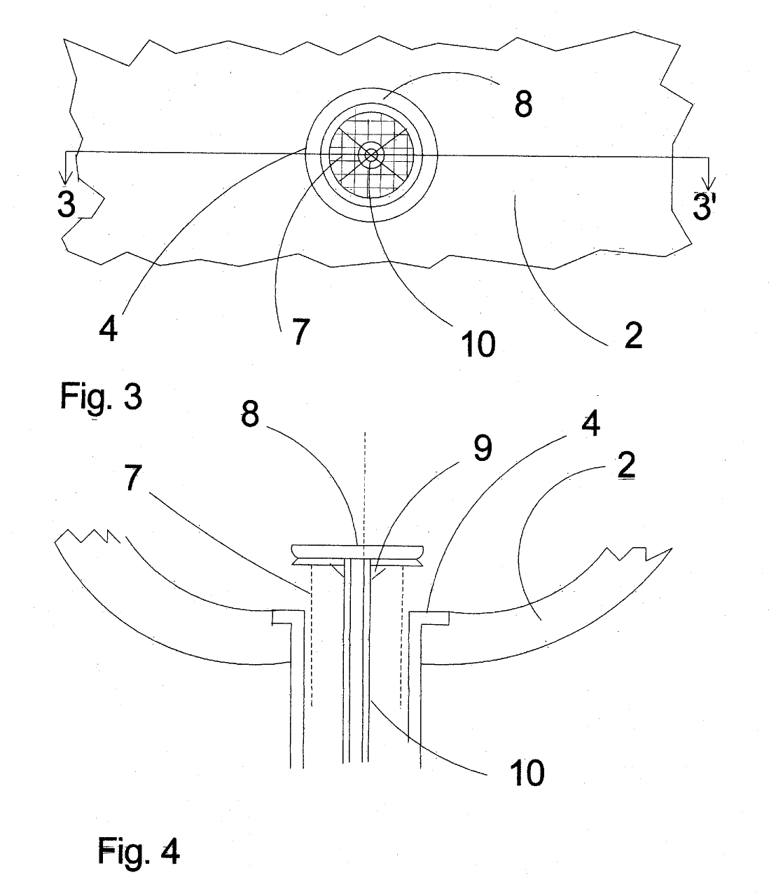

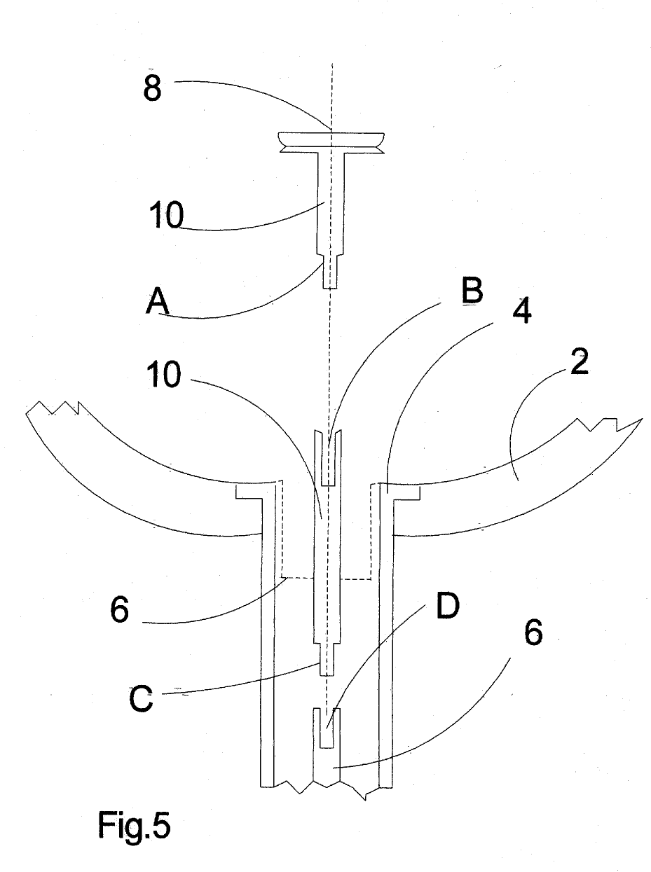

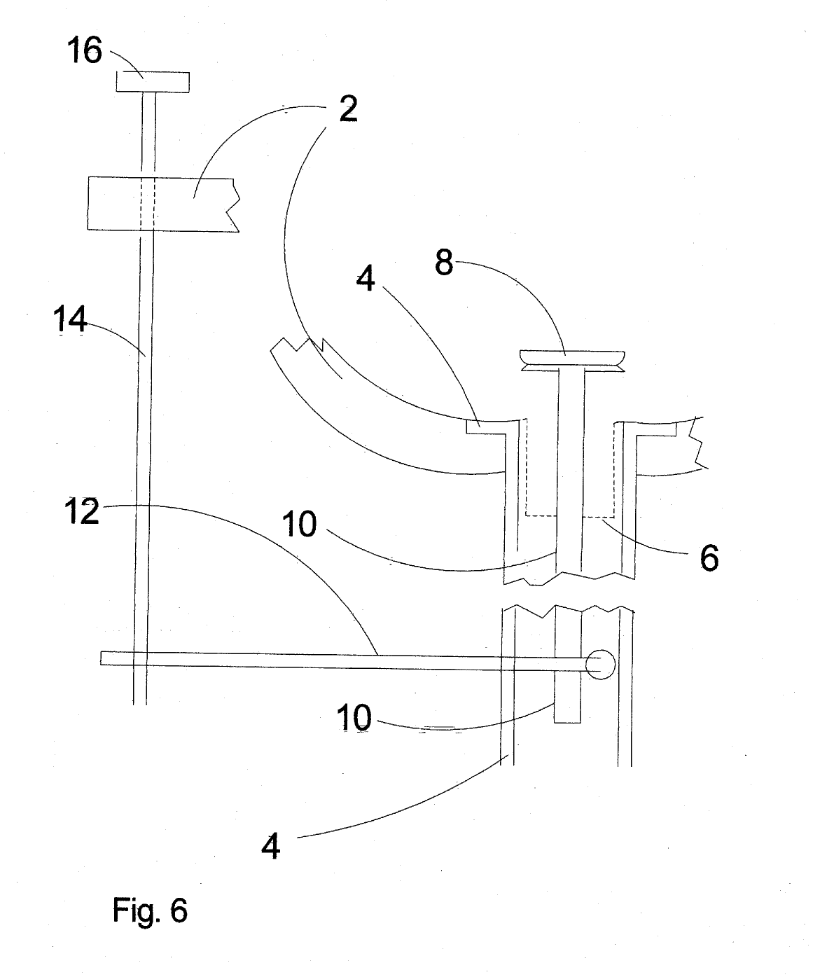

FIG. 5 shows an expanded view of the first embodiment of FIG. 2. in which the popup stopper can be easily detached at A to B or C to D for ease of cleaning or removal of the filter.

FIG. 6 shows a cross-sectional view of the pop-up stopper attached to the plunger on the back of the sink.

### DETAILED DESCRIPTION OF THE PREFERRED EMBODIMENTS

In accordance with the present invention the novel pop-up stopper apparatus with a filter for a wash basin and method of fabrication are described in more detail.

Referring first to FIG. 1, a schematic top view of a portion of a bathroom basin (2) is shown having a pop-up stopper (8) with a filter (6) according to the first embodiment. The pop-up 8 and filter 6 are attached to a shaft 10 that is aligned concentric with the drain pipe 4 in the basin 2.

Referring to FIG. 2, a schematic cross-sectional side view is shown through 1-1′ of FIG. 1, to better appreciate the invention. The structure is shown with the stopper in an open position. In this open position with the stopper open to a height h above the drain pipe 4, and the filter 6 is recessed below the drain pipe 4 to a stop 5 which results in the top of filter 6 being flush with the top of drain pipe 4. Not shown, but if necessary the filter 6 can also have a gasket on the upper rim of filter 6 to align the filter 6 to shaft 10 and or drain pipe 4. Although, the filter 6 is depicted as cylindrical in shape, it should also be understood that filter 6 can also have other shapes, such as, cone shape, cup shaped and the like. The pop-up stopper is preferably composed of non-oxidizing or non-corrosive materials such as stainless steel, chrome plated, plastic and the like.

Referring next to FIG. 3, a schematic top view of a portion of a bathroom basin 2 is shown having a pop-up stopper 8 with an inverted filter 7 according to the second embodiment. In this second embodiment the inverted filter 7 is secured to the stopper 8 by a flange 9 attached to the shaft 10.

Referring to FIG. 4, and to better appreciate this second embodiment, a schematic cross sectional view through 3-3′ of FIG. 3, is shown in FIG. 4. With the pop-up stopper 8 in the open position the filter 7 is sufficiently recessed in the drain tube 4 to a depth E to prevent hair and other debris from bypassing filter 7 and entering the drain pipe 4. Also, not shown, an open flange (spacer) can be used to align the filter 7 to the shaft 10 at a point above the depth E.

Referring next to FIG. 5, an expanded cross sectional view is shown through 1-1′ for the first embodiment in FIGS. 1 and 2, and shows a key feature of the invention. The pop-up stopper is designed so top 8 can be easily removed for cleaning the filter 6. More specifically the top 8 is designed to separate between A and B to expose the filter 6 for ease of cleaning without requiring the dismantling of the complete pop-up stopper as shown in FIG. 6. Also, as shown in FIG. 5, if necessary the filter 6 on shaft 10 can also be removed if necessary to replace because of damage by separating connector C from D. The connectors A to B and C to D Preferably a treaded connector, but can also be a bayonet type connector, a quick disconnect connectors or the like.

Referring finally to FIG. 6, the complete pop-up stop assembly is shown to appreciate the novelty of the invention. The pop-up stopper consists of a stopper 8 attached to the shaft 10 that is easy to remove at connection A-B (see FIG. 5) for cleaning the filter 6. The filter 6 is attach to a portion of the shaft 10 at C-D, as shown in FIG. 5, to allow the filter 6 to be easily removed for replacement if necessary. The remaining pop-up stopper structure and assembly are similar to a more conventional structure. In the more convention portion of the invention the bottom of shaft 10 is attached by a horizontal rod 12 that is attached to the vertical plunger rod 14 that extends up through the sink 2, to a plunger 16, usually behind the faucets (not shown). For simplicity, only portions of the sink 2 are shown.

While this pop-up stopper design with filters for easy cleaning and replacing is specifically shown for bathroom wash basins it should be understood that the novel feature can be used on bath tube drains, shower drains, utility-sink drains and the like.

What is claimed is:

1. A pop-up stopper with a filter, comprising:
a pop-up top attached to a shaft;
said filter under and concentric with said pop-up top and attached to said shaft;
said shaft extending vertically in a drain of a water basin 2;
said pop-up stopper attached to a plunger on top surface of said water basin to open and close said pop-up stopper in said drain;

2. The structure of claim 1, wherein said filter is cylindrical or cone shaped and can be cleaned or replaced by removing said top from said pop-up stopper.

3. The structure of claim 1, wherein said top is attached to said vertical shaft with a treaded connector, a bayonet connector or a quick disconnect connector.

4. The structure of claim 1, wherein said pop-up stopper and filter are made from rust resistant materials.

5. The structure of claim 1, wherein said filter is recessed below top of said drain when said pop-up stopper is in an open position.

6. The structure of claim 1, wherein said filter is in an inverted position and adjacent to said pop-up top when said pop-up stopper is in a open position.

7. A method of fabricating a pop-up stopper with a filter, comprising of:
forming a filter under and concentric with a pop-up top and attached to a shaft;
wherein said shaft extending vertically in a drain of a water basin;
wherein said pop-up stopper attached to said shaft is also attached to a plunger on top surface of said water basin by means of a horizontal rod and vertical rod to open and close said pop-up stopper in said drain.

8. The method of claim 7, wherein said filter is cylindrical or cone shaped and can be cleaned or replaced by removing said pop-up top from said pop-up stopper.

9. The method of claim 7, wherein said pop-up top is attached to said vertical shaft with a treaded connector, a bayonet connector or a quick disconnect connector.

10. The method of claim, wherein said pop-up stopper and filter are made from rust resistant materials.

11. The method of claim 7, wherein said filter is recessed below top of said drain when said pop-up stopper is in an open position.

12. The method of claim 7, wherein said filter is in an inverted position and adjacent to said pop-up top when said pop-up stopper is in an open position.
